(19) United States
(12) Patent Application Publication
(10) Pub. No.: US 2015/0215401 A1
(43) Pub. Date: Jul. 30, 2015

(54) STORAGE AREA NETWORK SEARCHING UTILITY

(71) Applicant: THOMSON LICENSING, Issy de Moulineaux (FR)

(72) Inventors: Vikram Jayakumar, North Hollywood, CA (US); George Zidd, Burbank, CA (US); Vince Cerundolo, Pasadena, CA (US)

(73) Assignee: THOMSON LICENSING, Issy de Moulineaux (FR)

(21) Appl. No.: 14/167,829

(22) Filed: Jan. 29, 2014

(51) Int. Cl. H04L 29/08; G06F 17/30

(52) U.S. Cl. CPC H04L 67/1097; G06F 17/30864; G06F 17/30106; G06F 17/302

(57) ABSTRACT

A method and system for accessing files in a non-volatile storage medium is disclosed. The accessing files in a non-volatile storage medium includes choosing an active directory of a storage area network, the storage area network being a part of a non-volatile storage medium; selecting an edit decision list associated with the active directory; performing a search of the active directory, resulting in a plurality of files found on the storage area network; placing the plurality of files in a selected folder; and linking the selected folder with the active directory in the storage area network.

### FIELD OF INVENTION

The present disclosure relates to accessing non-volatile storage media, and more particularly, to a method for aggregating files from a non-volatile storage area network.

### BACKGROUND

In the television and motion picture industry, video editors generate what is known as an “edit decision list” (“EDL”). These lists are used in the post-production phase of film and video editing. Contained in these EDL's are ordered lists of metadata (e.g. reel and timecode information) about predetermined video clips to be used as part of the conforming process. This process entails moving information that is stored in non-volatile storage media to a server having volatile storage media. This server, known as a storage area network (“SAN”), is available to a multitude of authorized users to allow the users to manipulate the stored data as desired. Currently this process must be done entirely in a LINUX terminal. While some users are comfortable navigating through the LINUX terminal, many video editors would prefer a more user-friendly interface.

### SUMMARY

The below embodiments relate to a system capable of generating a graphical user interface for accessing a SAN. While many of the below embodiments are directed towards use in the television and motion picture industries, the below embodiments can also be used in any industry that employs a SAN. The disclosed embodiments provide a graphical user interface to allow users to search a SAN for events in an EDL. Further, the embodiments also link media into a specially created folder that contains only the media required for the EDL. This folder has the benefit of being conform-ready. This means the files are available for immediate use in post production and video editing as opposed to being in an archived format on the SAN.

In one embodiment, a method of accessing files in a non-volatile storage medium is disclosed. The method includes choosing an active directory of a storage area network, the storage area network being a part of a non-volatile storage medium, selecting an edit decision list associated with the active directory, performing a search of the active directory, resulting in a plurality of files found on the storage area network, placing the plurality of files in a selected folder; and linking the selected folder with the active directory in the storage area network.

### BRIEF DESCRIPTION OF THE DRAWINGS

For a more complete understanding of the present disclosure, reference is made to the following detailed description of an embodiment considered in conjunction with the accompanying drawings, in which:

FIG. 1 is a diagram illustrating a system for aggregating files from a SAN in accordance with one embodiment of the present disclosure; and

FIG. 2 is a flow chart illustrating a method of aggregating files from a SAN in accordance with one embodiment of the present disclosure;

FIG. 3 illustrates a graphical user interface showing a sample rendering of a listing of directories upon which a search can be performed;

FIG. 4 illustrates a graphical user interface showing a listing of the results of the file search; and

FIG. 5 illustrates a graphical user interface showing a sample rendering of the results of the file search.

### DETAILED DESCRIPTION

The following disclosure is presented to provide an illustration of the general principles of the present disclosure and is not meant to limit, in any way, the inventive concepts contained herein. Moreover, the particular features described in this section can be used in combination with the other described features in each of the multitude of possible permutations and combinations contained herein.

All terms defined herein should be afforded their broadest possible interpretation, including any implied meanings as dictated by a reading of the specification as well as any words that a person having skill in the art and/or a dictionary, treatise, or similar authority would assign particular meaning. Note that “conforming” can be interpreted as meaning replacing “offline” materials (e.g. something stored on an LTO storage device in an archived format) with “online” materials, such as something stored locally or on volatile memory on an accessible server in a more accessible or easier to use format, supporting the process of generating different versions of a final cut of a television show or motion picture (i.e. creating a standard definition cut from a high definition cut).

Further, it should be noted that, as recited in the specification and in the claims appended herein, the singular forms ‘a,’ “an,” and “the” include the plural referents unless otherwise stated. Additionally, the terms “comprises” and “comprising” when used herein specify that certain features are present in that embodiment, however, this phrase should not be interpreted to preclude the presence or additional of additional steps, operations, features, components, and/or groups thereof. Generally, editors must take a non-trivial amount of time assembling all of the necessary video clips pursuant to an EDL. Due to the fact that many videos assembled for the television industry must be completed within a relatively short time-frame, tools and methods that can expedite the editing process are highly desired. Typically the video clips or other files are stored in an archived format (such as LTO) as part of the SAN. To make use of the video clips or files they need to be retrieved from the SAN and converted from the archival format to more accessible formats. The disclosed embodiments describe a method and utility for allowing a user to search an online SAN for the files delineated in an EDL. These disclosed embodiments also link out media into a specially created folder to create a conform-ready folder consisting solely of the media needed for that particular EDL.

The embodiments can be performed on any UNIX-based computer or a different type of computer that is running a virtualization of such a UNIX-based computer. Additionally, the embodiments can also be executed on a UNIX-based server, which then provides the end-result of the embodiment to the user. Most embodiments are stored on computer-readable storage media, such as disk drives, compact disks (CDs), digital video disks (DVDs), or across a transmission medium, such as the Internet. The program code may be executed as a stand-alone software package, or the operations performed therein may be distributed across a number of computers.

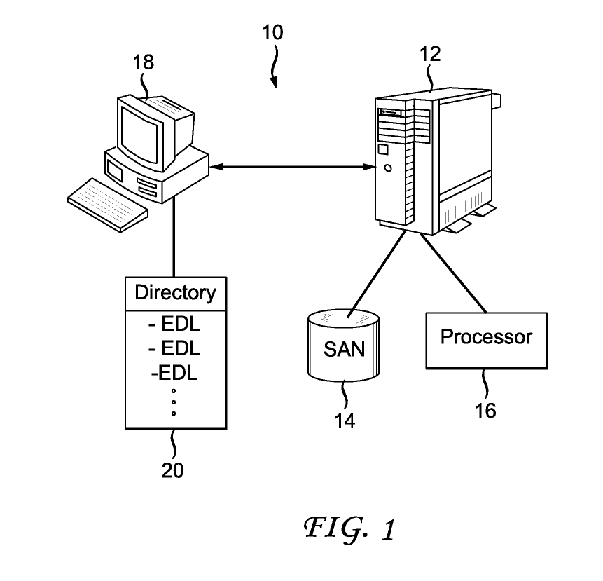

FIG. 1 illustrates a system 10 for aggregating files from a SAN according to an embodiment of the present disclosure. The system includes a server 12 including a storage area network (i.e., SAN) 14 and a processor 16, and a computer 18 using a client having a directory 20 of EDLs stored thereon. The user interacts with the server 12 through a graphical user interface (“GUI”) on the computer 18 that allows the user to search through the SAN 14 for files according to one of the EDLs stored on the directory 20. Once found, these files can be sent back to the user through the GUI.

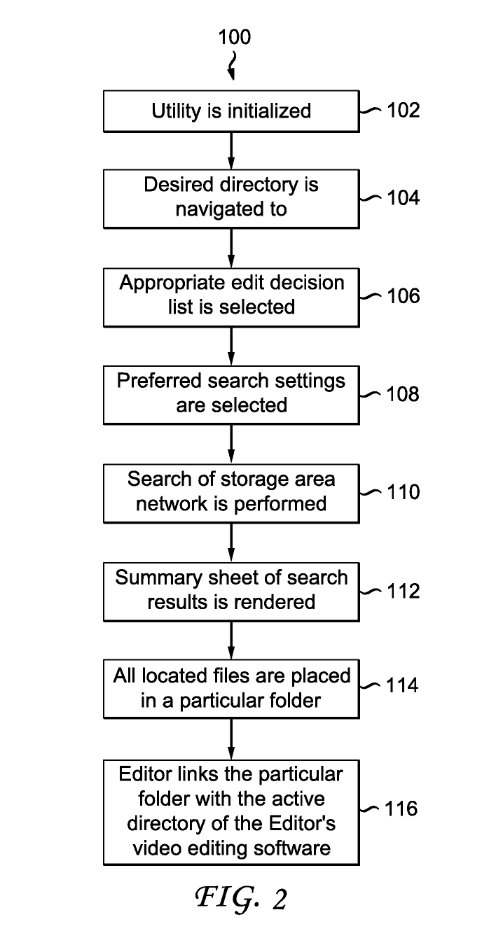

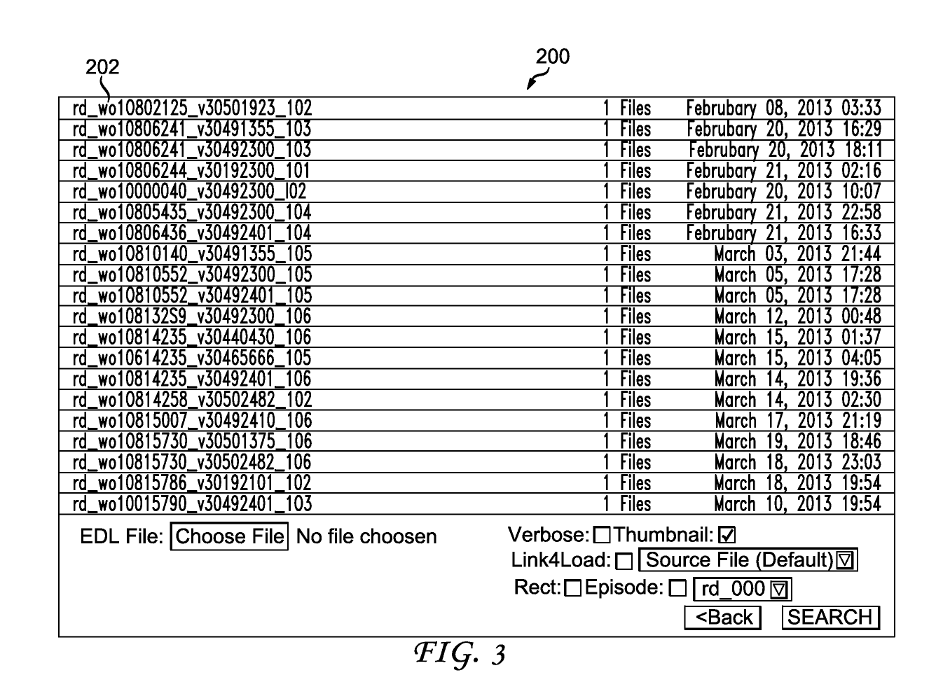

FIG. 2 illustrates a method 100 of aggregating files from a SAN according to an embodiment of the present disclosure. At the outset, a user initializes the utility (step 102) and navigates to a desired directory (step 104). FIG. 3 illustrates a graphical user interface 200 showing a list of directories 202 from which the user may select the desired directory. Referring back to FIG. 2, upon arriving at the desired directory, the user selects the corresponding EDL (step 106) and some parameters of the search to be performed on the files listed in the EDL (step 108). These parameter options include, but are not limited to, “Verbose” for displaying error messages, “Thumbnails” for displaying image previews of the files, “Link4Load” for linking the found files in one directory, “RED” to allow the utility to interface with RED files while allowing the RED file structure to be maintained, and “Episode” for selecting a particular episode to which the files are linked.

Upon choosing the appropriate parameter options, a user then initiates the search of the files listed in the EDL (step 110). At the completion of the search, a summary sheet of the search results is generated (step 112) and all located files are placed in a readily available folder (step 114). The summary sheet contains a list of all the files listed on the EDL that were found. The summary can also include an error message for any files that the search function failed to retrieve. The readily available folder is then linked to the active directory of the user's video editing program (step 116).

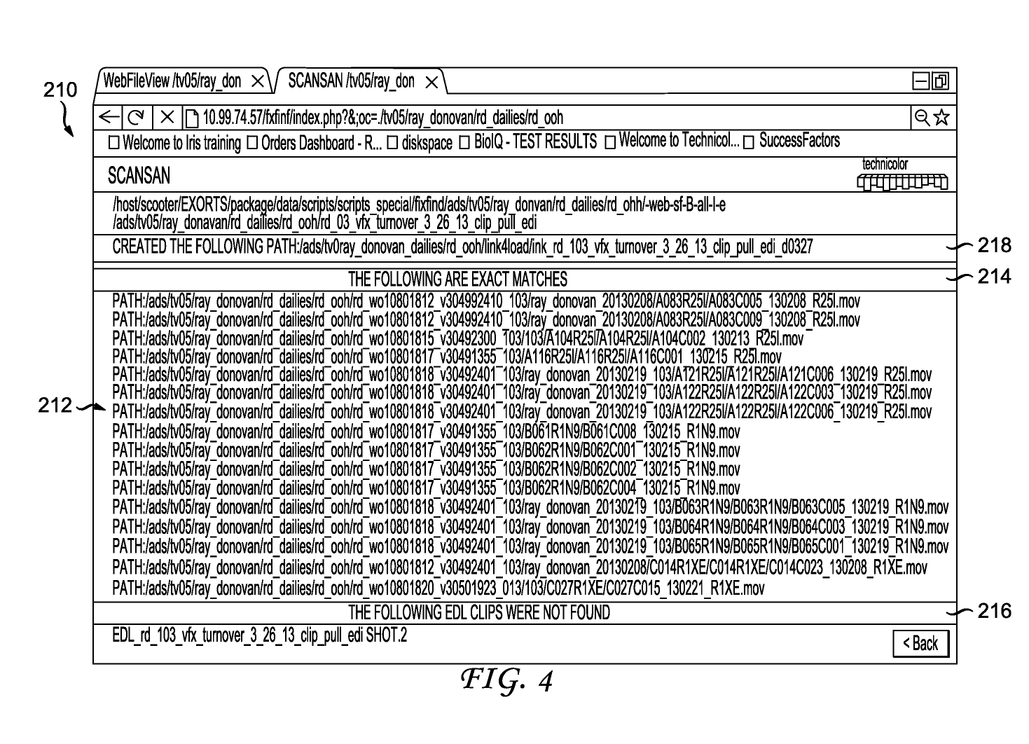

FIG. 4 illustrates an example of a graphical user interface 210 in which the search results 212 are displayed. The search results 212 include a first section 214 where exact matches were found, as well as second section 216 showing which files listed in the EDL were not found in the directory. The graphical user interface 210 also includes a display showing a path 218 where located filed are linked as a result of the process discussed above.

In one embodiment, the system links between the active directory and the folders are hard links. Such links include multiple filenames pointing to one particular group of data.

In one embodiment, the folder containing the desired files is made available in any standard web browser. The utility provides a user web browser-friendly directory path which is entered into any standard web browser on a computer that has access to the folder containing the desired files.

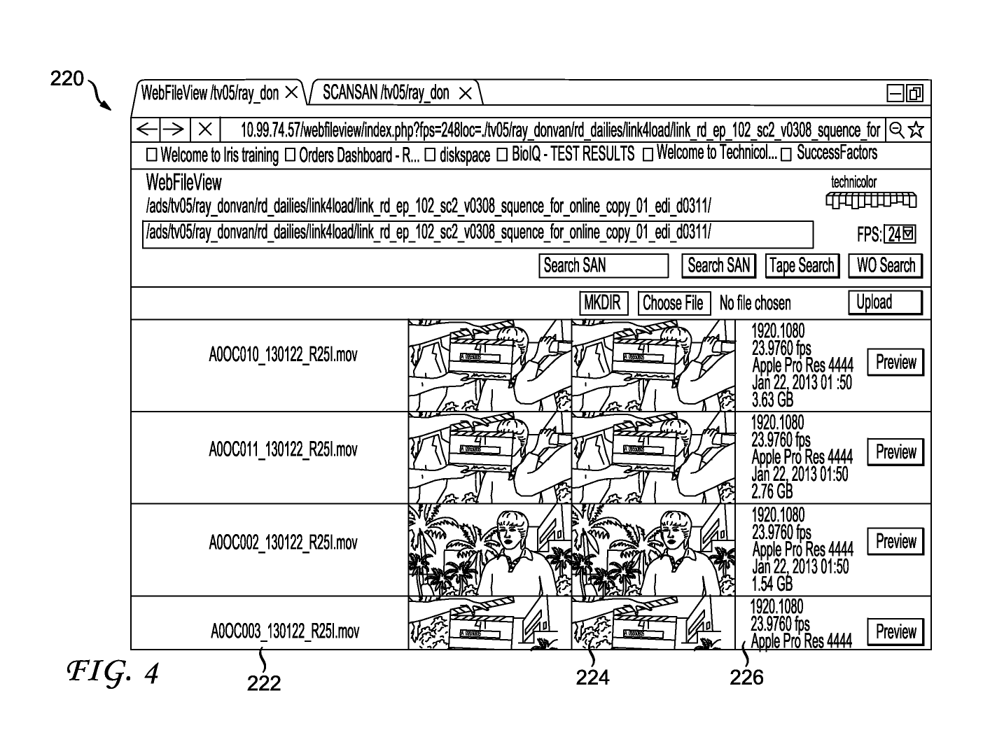

In one embodiment, the system allows a user to aggregate a number of desired files as dictated by an EDL. This system includes a computer containing an EDL, an instance of a software utility capable of matching the information in said EDL with a large database containing the locations of all potentially desirable video files, and a web browser for displaying the aggregated files in a graphical user interface. FIG. 5 illustrates an example of a graphical user interface 220 according to this embodiment. As shown, the graphical user interface 220 renders the contents of a folder in a web browser and includes the name of the file 222, a thumbnail 224 representing the file, and a display 226 of metadata of associated with the file.

In another embodiment, the disclosed utility is executed on a remote server and pushes rendered images of the graphical user interface to the user's computer. In this embodiment, any memory intensive being run on a system could be adjusted for the utility's needs as opposed to the user's hardware being the limiting factor on the speed of the embodiments' execution of its function.

In another embodiment, the system described above executes the software utility on a remote server, but the web browser is still rendered on a first, local computer. This allows any memory intensive program being run on a system to be adjusted for the utility's needs as opposed to the user's hardware being the limiting factor on the speed of the embodiments' execution of its function.

The various embodiments disclosed herein can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It will be understood that the embodiments described herein are merely exemplary and that a person skilled in the art may make many variations and modifications without departing from the spirit and scope of the disclosure. All such variations and modifications are intended to be included within the scope of the disclosure as defined in the appended claims.

We claim:

1. A method of accessing files in a non-volatile storage medium, the method comprising:
choosing an active directory of a storage area network, the storage area network being a part of a non-volatile storage medium;
selecting an edit decision list associated with the active directory;
performing a search of the active directory based on the edit decision list, the search resulting in a plurality of files found on the storage area network;
placing the plurality of files in a selected folder; and
linking the selected folder with the active directory in the storage area network.

2. The method of claim 1, further comprising generating a summary sheet of the plurality of files found on the storage area network.

3. The method of claim 2, wherein the summary sheet also includes the files not found on the storage area network.

4. The method of claim 1, wherein the linking includes generating hard links between the selected folder and the active directory, said hard links including multiple file names pointing to a single group of data.

5. The method of claim 1, wherein the method is performed using a web browser on a computer.

6. The method of claim 1, wherein the method is performed on a server.

7. A system for providing access to non-volatile storage media, comprising:
a storage area network embodied in a non-volatile storage medium; and
a processor configured to
choose an active directory of the storage area network;
select an edit decision list associated with the active directory;
perform a search of the active directory based on the edit decision list, the search resulting in a plurality of files found on the storage area network;
place the plurality of files in a selected folder; and
link the selected folder with the active directory in the storage area network.

8. The system of claim 7, wherein the processor is further configured to receive commands from a user connected to the system and provide the link to the selected folder to the user.

9. The system of claim 7, wherein the processor is further configured to generate a summary sheet of the plurality of files found on the storage area network.

10. The system of claim 9, wherein the summary sheet also includes the files not found on the storage area network.

11. The system of claim 7, wherein the linking includes generating hard links between the selected folder and the active directory, said hard links including multiple file names pointing to a single group of data.

12. A non-transitory computer-readable medium and instructions stored thereon for causing a processor to perform the following actions:
choosing an active directory of a storage area network, the storage area network being a part of a non-volatile storage medium;
selecting an edit decision list associated with the active directory;
performing a search of the active directory based on the edit decision list, the search resulting in a plurality of files found on the storage area network;
placing the plurality of files in a selected folder; and
linking the selected folder with the active directory in the storage area network.
